(19) United States
(12) Patent Application Publication
(10) Pub. No.: US 2012/0139524 A1
(43) Pub. Date: Jun. 7, 2012

(54) CONSTANT CURRENT CIRCUIT

(75) Inventor: Atsuhisa SUZUKI, Kanagawa-ken (JP)

(73) Assignee: KABUSHIKI KAISHA TOSHIBA, Tokyo (JP)

(21) Appl. No.: 13/050,846

(22) Filed: Mar. 17, 2011

(30) Foreign Application Priority Data
Dec. 1, 2010 (JP) 2010-268004

(51) Int. Cl. G05F 3/26

(52) U.S. Cl. 323/315

(57) ABSTRACT

According to one embodiment, a constant current circuit, including A constant current circuit, a current mirror circuit generating an output current, an external terminal to which an external resistance is connected, a reference current to be supplied to the current mirror circuit depending on the external resistance, a first detection circuit detecting an open state of the external terminal, and an alternative circuit supplying an alternative current corresponding to the reference current into the current mirror circuit when the first detection circuit detects the open state.

### CROSS REFERENCE TO RELATED APPLICATION

This application is based upon and claims the benefit of priority from prior Japanese Patent Application No. 2010-268004, filed on Dec. 1, 2010, the entire contents of which are incorporated herein by reference.

### FIELD

Exemplary embodiments described herein generally relate to a constant current circuit.

### BACKGROUND

A circuit which includes an operational amplifier, an NMOS transistor, a gate voltage of which is controlled according to an output of the operational amplifier, and a current mirror circuit which converts a current flowing in the NMOS transistor according to a predetermined mirror ratio is generally used as a circuit to supply a constant current.

In the constant current circuit, a resistance is connected between a source terminal of the NMOS transistor and a ground terminal, and a voltage of the source terminal is fed back to an inverting input terminal of the operational amplifier.

A reference voltage is applied to a non-inverting input terminal of the operational amplifier. The operational amplifier controls the gate voltage of the NMOS transistor in such a manner that the voltage fed back from the source terminal of the NMOS transistor is kept equal to the reference voltage.

Accordingly, a current I to flow in the NMOS transistor is a constant current represented by

I=Vref/R

where Vref is the reference voltage and R is a resistance value of the resistance connected to the source terminal of the NMOS transistor.

The current mirror circuit outputs a constant output current obtained by converting the current I according to a predetermined mirror ratio.

The constant current circuit can output an output current of a desired value by setting the resistance value R of the resistance to a suitable value. Here, accuracy of the output current varies depending on accuracy of the resistance value R.

In order to obtain an accurate constant current, it is a conventional practice to attach an external resistance having high accuracy as the above-mentioned resistance to an integrated circuit serving as the constant current circuit.

This is because it is difficult to manufacture an accurate resistance built in an integrated circuit due to manufacturing variation or the like.

Providing the external resistance having high accuracy in this way enables the integrated constant current circuit to output a constant current with high accuracy.

On the other hand, however, the resistance having high accuracy needs to be connected to an external terminal of the integrated circuit by soldering, for example. Accordingly, a problem arises in that the constant current circuit cannot provide a normal output current when connection defects occur due to poor soldering, for example.

### BRIEF DESCRIPTION OF THE DRAWINGS

FIG. 1 is a circuit diagram illustrating an exemplary structure of a constant current circuit according to a first embodiment;

FIG. 2 is a diagram illustrating the occurrence of an open defect at a connection of an external resistance according to the first embodiment;

FIG. 3 is a diagram illustrating operation of an alternative circuit included in the constant current circuit according to the first embodiment;

FIG. 4 is a circuit diagram illustrating an exemplary structure of a constant current circuit according to a second embodiment;

FIG. 5 is a circuit diagram illustrating operation of an alternative circuit included in the constant current circuit according to the second embodiment;

FIG. 6 is a circuit diagram illustrating an exemplary structure of a constant current circuit according to a third embodiment;

FIG. 7 is a circuit diagram illustrating an exemplary structure of a constant current circuit according to a fourth embodiment;

FIG. 8 is a circuit diagram illustrating an exemplary structure of a constant current circuit according to the fifth embodiment;

FIG. 9 is a circuit diagram illustrating recovery of the connection of the external resistance from an open state according to the fifth embodiment;

### DETAILED DESCRIPTION

According to one embodiment, a constant current circuit, including a current mirror circuit generating an output current, an external terminal to which an external resistance is connected, a reference current to be supplied to the current mirror circuit depending on the external resistance, a first detection circuit detecting an open state of the external terminal, and an alternative circuit supplying an alternative current corresponding to the reference current into the current mirror circuit when the first detection circuit detects the open state.

Embodiments will be described below in detail with reference to the attached drawings mentioned above. Throughout the attached drawings, similar or same reference numerals show similar, equivalent or same components.

### First Embodiment

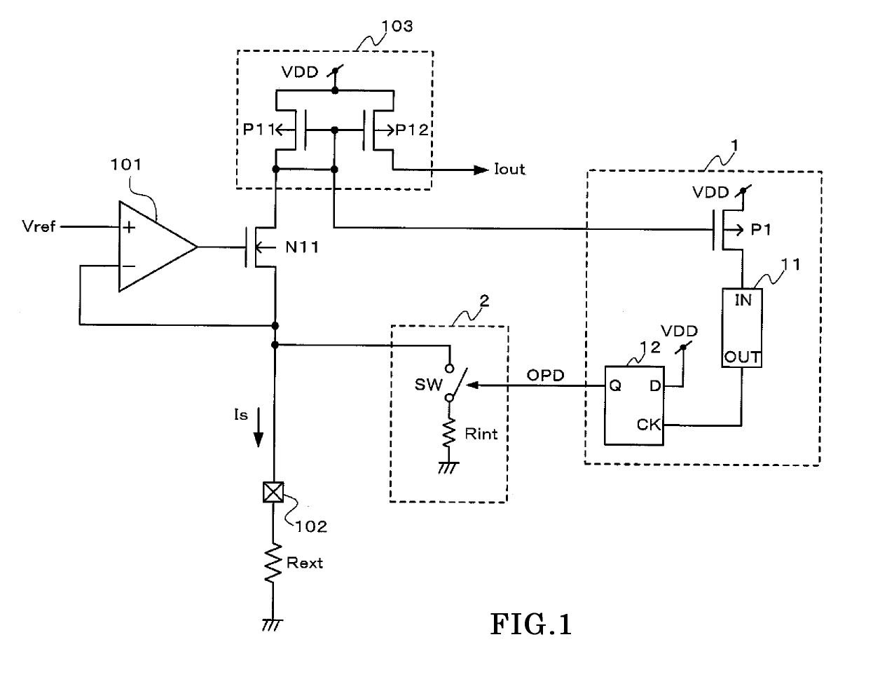

FIG. 1 is a circuit illustrating an exemplary structure of a constant current circuit according to a first embodiment.

The basic structure of a constant current circuit of the first embodiment is similar to that of a typical conventional constant current circuit, and includes an operational amplifier 101, an NMOS transistor N11, an external resistance Rext, and a current mirror circuit 103. A reference voltage Vref is applied to a non-inverting input terminal of the operational amplifier 101. An output of the operational amplifier 101 is applied to a gate terminal of the NMOS transistor N11. The external resistance Rext is connected to a ground point and to a source terminal of the NMOS transistor N11 through an external terminal 102. The current mirror circuit 103 is connected to a drain terminal of the NMOS transistor N11. The source terminal of the NMOS transistor N11 is connected to an inverting input terminal of the operational amplifier 101.

In the structure, a reference current Is flows in the NMOS transistor N11 when the external resistance Rext is normally connected to the external terminal 102. Here, Is equals to Vref/Rext, where Vref is the reference voltage and Rext is a resistance value of the external resistance Rext.

The current mirror circuit 103 includes a PMOS transistor P11 having a drain terminal and a gate terminal which are connected to the drain terminal of the NMOS transistor N11, and a PMOS transistor P12 having a gate terminal connected to the drain terminal of the NMOS transistor N11. The current mirror circuit 103 outputs an output current Iout from a drain terminal of the PMOS transistor P12 as a constant current. The ratio of the output current Iout to the reference current Is is a mirror ratio. The mirror ratio depends on an element size ratio of the PMOS transistors P11, P12.

The constant current circuit in this embodiment further includes a detection circuit 1 and an alternative circuit 2 in addition to the above-described structure. The detection circuit 1 detects an open state of the external terminal 102. The alternative circuit 2 supplies an alternative current Ia corresponding to the reference current Is to the current mirror circuit 103 when the detection circuit 1 detects the open state of the external terminal 102.

The detection circuit 1 in the embodiment includes a PMOS transistor P1, a detection circuit 11, and a latch 12. The PMOS transistor P1 has a gate terminal connected to the drain terminal of the NMOS transistor N11. The detection circuit 11 detects decrease in a current flowing in a drain terminal of the PMOS transistor P1. The latch 12 latches an output signal of the detection circuit 11.

A current mirror circuit is constituted with the PMOS transistor P1 of the detection circuit 1 and the PMOS transistor P11 of the current mirror circuit 103. In normal operation, a constant current proportional to the reference current Is flows in the drain terminal of the PMOS transistor P1.

The detection circuit 11 outputs an L-level signal when the above constant current flows in the drain terminal of the PMOS transistor P1, while the detection circuit 11 outputs an H-level signal when the current flowing in the drain terminal of the PMOS transistor P1 decreases below the constant current.

The latch 12 has a clock terminal which receives an output signal of the detection circuit 11 and a data terminal which receives a power source voltage VDD. Thus, the latch 12 operates in such a manner that an output of an output terminal Q turns to an H-level when the output signal of the detection circuit 11 turns to the H-level from an L-level, and after the change, keeps the H-level even when the output signal of the detection circuit 11 changes. The output signal of the latch 12 is an open state detection signal OPD serving as an output signal of the detection circuit 1.

The alternative circuit 2 in the embodiment also includes an internal resistance Rint and a switch SW which connects the internal resistance Rint to the external terminal 102 in a semiconductor integrated circuit when the detection circuit 1 outputs the open state detection signal OPD. In other words, the switch SW is off when the open state detection signal OPD is the L-level while the switch SW turns on so as to connect the internal resistance Rint to the external terminal 102 when the open state detection signal OPD turns to the H-level.

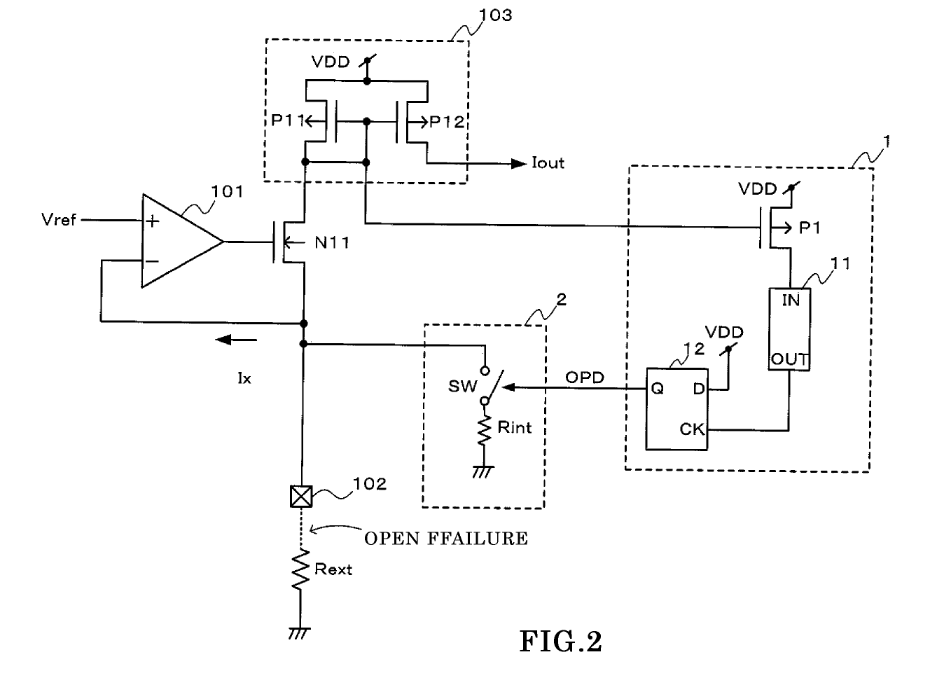

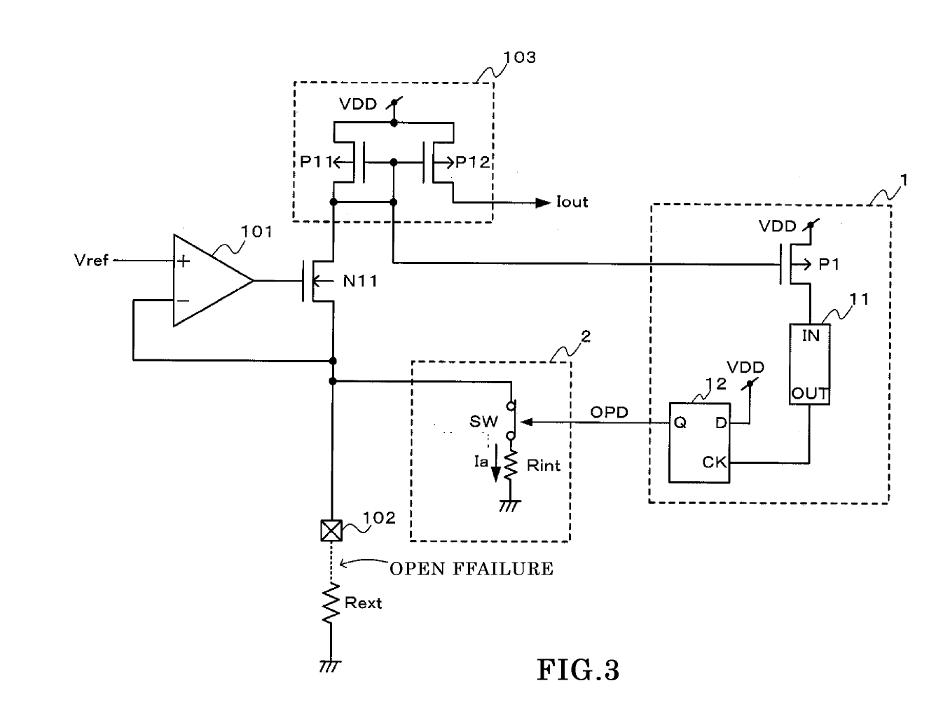

Next, description is given of the operation of the constant current circuit of the embodiment observed when an open defect occurs at a connection between the external terminal 102 and the external resistance Rext with reference to FIGS. 2 and 3.

As illustrated in FIG. 2, when the open defect occurs at the connection between the external terminal 102 and the external resistance Rext, a current flowing in the NMOS transistor N11 is decreased to a degree of a leak current flowing in the inverting input terminal of the operational amplifier 101. The current is referred to as an abnormal current Ix, herein.

Accordingly, a drain current of the PMOS transistor P1 of the open state detection circuit 1 also greatly is decreased as compared to that of a normal state because the drain current is a mirror current of the abnormal current Ix. The detection circuit 11 detects the current decrease, so that the open state detection signal OPD outputted from the latch 12 turns to the H-level from the L-level.

As illustrated in FIG. 3, when the open state detection signal OPD turns to the H-level, the switch SW of the alternative circuit 2 turns on, so that the internal resistance Rint is electrically connected to the external terminal 102. As a result, the alternative current Ia flows from the NMOS transistor N11 to the internal resistance Rint. When a resistance value Rint is equal to the resistance value Rext, i.e., Rint=Rext, the alternative current Ia is equal to the reference current Is, i.e., Ia=Is. Hence, the output current Iout of the current mirror circuit 103 is also equal to a current outputted when the external resistance Rext is normally connected.

In this case, however, current accuracy of the output current Iout may lower because resistance value accuracy of the internal resistance Rint is lower than that of the external resistance Rext. Even though the accuracy is lowered, the constant current circuit can maintain its function of outputting a constant current.

According to the embodiment, when an open defect occurs at a connection between the external terminal 102 and the external resistance Rext, the detection circuit 1 detects decrease in a current flowing toward the external terminal 102, and the alternative circuit 2 electrically connects the internal resistance Rint to the external terminal 102. Consequently, the alternative current Ia equal to the reference current Is is supplied to the current mirror circuit 103 whereby the current mirror circuit 103 can provide the output current Iout equal to a current outputted when the external resistance Rext is normally connected.

### Second Embodiment

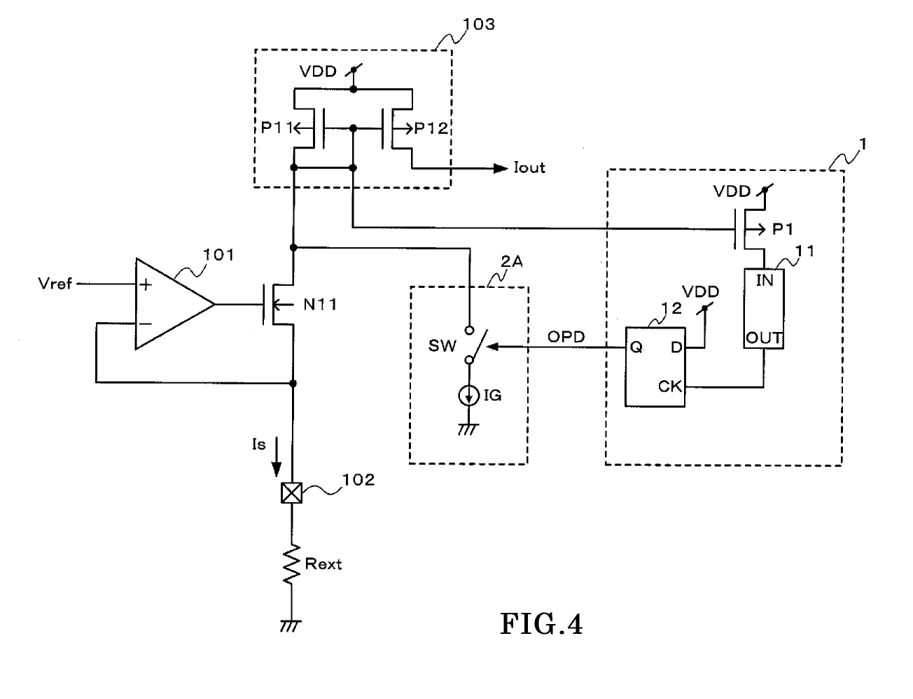

FIG. 4 shows a circuit illustrating an exemplary structure of a constant current circuit according to a second embodiment. A second embodiment differs from the first embodiment in that an alternative circuit 2A is connected to a drain terminal of a PMOS transistor P11 of a current mirror circuit 103. The difference from the first embodiment is mainly described, herein.

The alternative circuit 2A includes a constant current source IG and a switch SW which connects the constant current source IG to the drain terminal of the PMOS transistor P11 of the current mirror circuit 103 when an open state detection signal OPD outputted from an open state detection circuit 1 turns to the H-level.

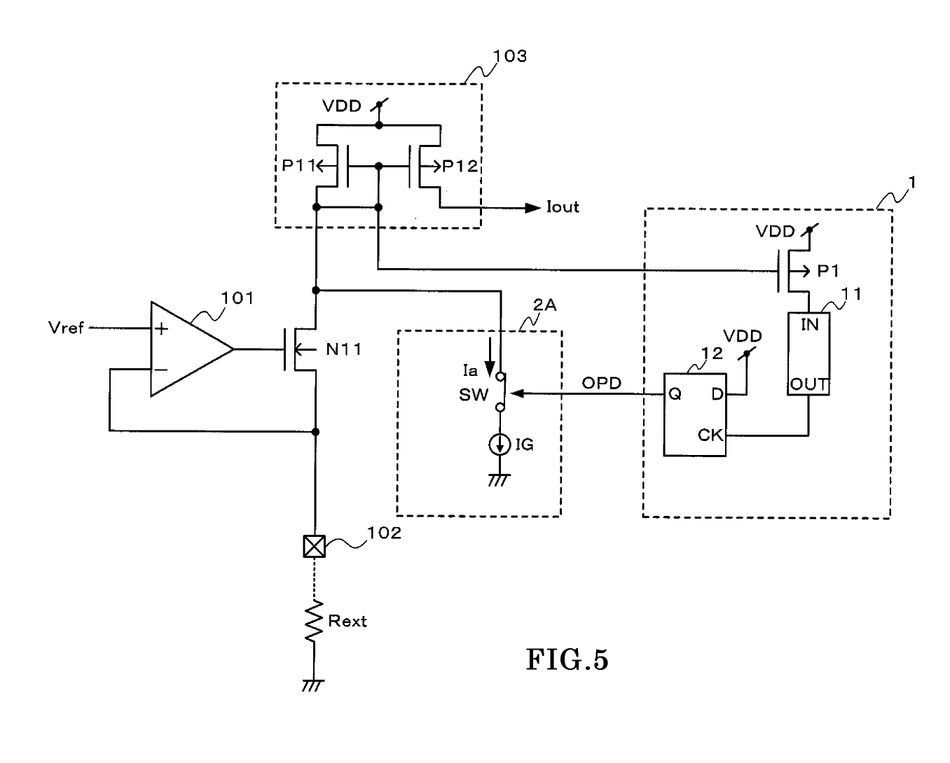

FIG. 5 illustrates how the circuit acts when the switch SW turns on.

When a current value of the constant current source IG is Ia, a current Ia of the constant current source IG is supplied to the current mirror circuit 103 as an alternative current of a reference current Is when the switch SW turns on. Accordingly, when the current Ia of the constant current source IG is designed to be equal to the reference current Is, i.e., Ia=Is, an output current Iout outputted at the state can be equal to a current outputted when an external resistance Rext is normally connected.

In the second embodiment as described above also, the alternative current Ia equal to the reference current Is is supplied to the current mirror circuit 103 when an open defect occurs at a connection between an external terminal 102 and the external resistance Rext. As a result, the current mirror circuit 103 can provide the output current Iout equal to a current outputted when the external resistance Rext is normally connected.

### Third Embodiment

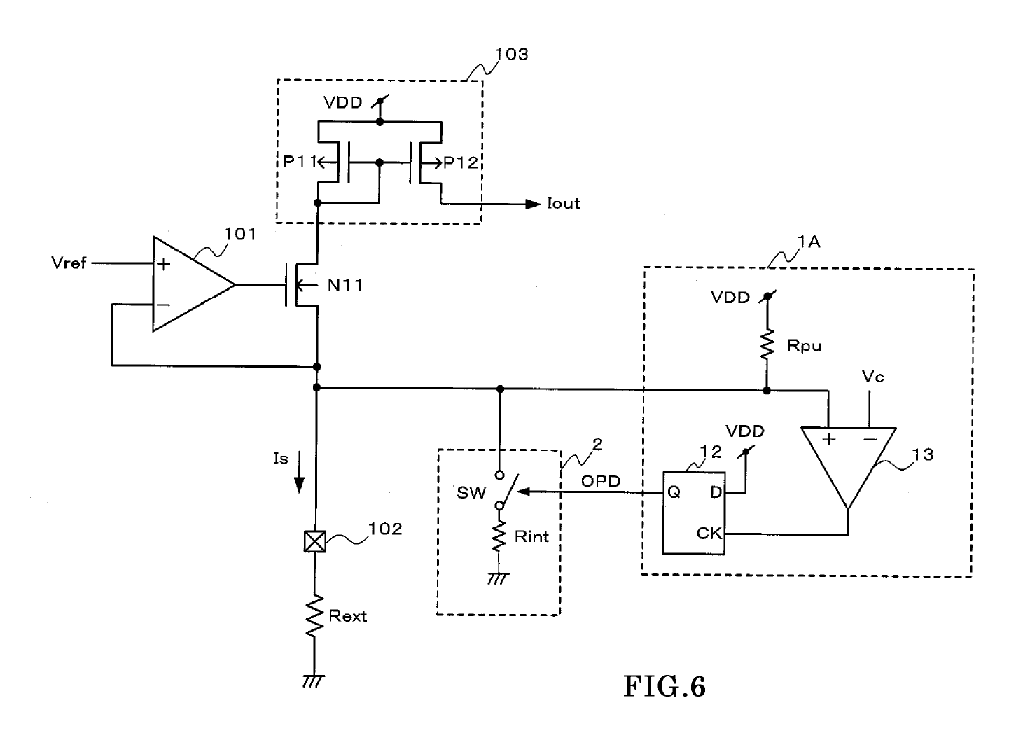

FIG. 6 shows a circuit illustrating an exemplary structure of a constant current circuit according to a third embodiment of the invention. The first embodiment describes an example in which an open defect of the external terminal 102 is detected by detecting decrease in a current flowing toward the external terminal 102. In contrast, the third embodiment describes an example in which an open defect of an external terminal 102 is detected by detecting change in a voltage of the external terminal 102. In the embodiment, a detection circuit 1A which detects an open state is connected to the external terminal 102 to detect change in a voltage of the external terminal 102.

The detection circuit 1A includes a pull-up resistance Rpu, a comparator 13, and a latch 12. The pull-up resistance Rpu is connected between the external terminal 102 and a power source voltage VDD line. The comparator 13 compares a voltage of the external terminal 102 with a comparative voltage Vc. The latch 12 has a clock terminal which receives an output signal of the comparator 13.

The comparator 13 has a non-inverting input terminal which receives the voltage of the external terminal 102 and an inverting input terminal which receives the comparative voltage Vc. The comparative voltage Vc is set to be a voltage between a reference voltage Vref and a power source voltage VDD, i.e., Vref<Vc<VDD. Accordingly, an output of the comparator 13 is the L-level when an external resistance Rext is normally connected to the external terminal 102 and the voltage of the external terminal 102 is the reference voltage Vref.

Next, description is given on the operation of the constant current circuit in the embodiment observed when an open defect occurs at a connection between the external terminal 102 and the external resistance Rext.

When an open defect occurs at a connection between the external terminal 102 and the external resistance Rext, an input voltage of the non-inverting input terminal of the comparator 13 is pulled up to the power source voltage VDD by the pull-up resistance Rpu, and becomes higher than the comparative voltage Vc. Hence, the output of the comparator 13 turns to the H-level from the L-level. As a result, the latch 12 latches the power source voltage VDD whereby an open state detection signal OPD serving as an output of the latch 12 turns to the H-level.

When the open state detection signal OPD turns to the H-level, a switch SW of an alternative circuit 2 turns on. Accordingly, an internal resistance Rint is electrically connected to the external terminal 102. Consequently, in the embodiment as described above, an output current Iout equal to the current outputted, when the external resistance Rext is normally connected, can be also provided in the same manner as the first embodiment.

Note that, in the embodiment, a current flowing in the pull-up resistance Rpu is added to a current flowing in an NMOS transistor N11, and the combined current serves as a reference current Is. Therefore, the resistance value of the pull-up resistance Rpu is set to be a higher value to reduce the effect of the pull-up resistance Rpu on a current supplied to the current mirror circuit 103.

### Fourth Embodiment

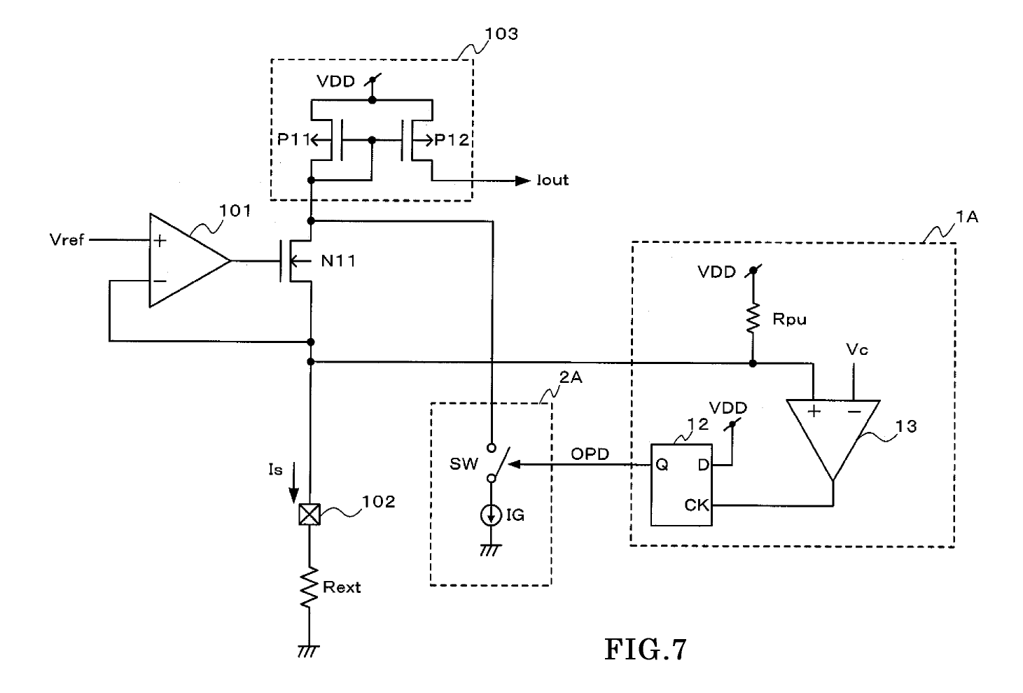

FIG. 7 shows a circuit illustrating an exemplary structure of a constant current circuit according to a fourth embodiment. The fourth embodiment is a case in which the alternative circuit 2 in the third embodiment is replaced with the alternative circuit 2A of the second embodiment.

In the embodiment, a switch SW of an alternative circuit 2A turns on so that a current of a constant current source IG is supplied to a current mirror circuit 103 when an open defect occurs at a connection between an external terminal 102 and an external resistance Rext, and an open state detection signal OPD serving as an output from an open state detection circuit 1A turns to the H-level.

In the same manner as the second embodiment, when a current of a constant current source IG is Ia and is designed to be Ia=Is, an output current Iout equal to a current outputted when the external resistance Rext is normally connected can be provided.

### Fifth Embodiment

The above embodiments describe examples each in which a defect which occurs at a connection between the external terminal 102 and the external resistance Rext is an open defect. However, the examples of such defect mode may include a loose connection. In the case of a loose connection, a connection state of the external resistance Rext is unstable, so that the connection state may return to normal after the connection state is once deemed as an open state. In such a case, the alternative current Ia does not need to be supplied. The fifth embodiment describes an exemplary circuit which can handle such loose connection mode.

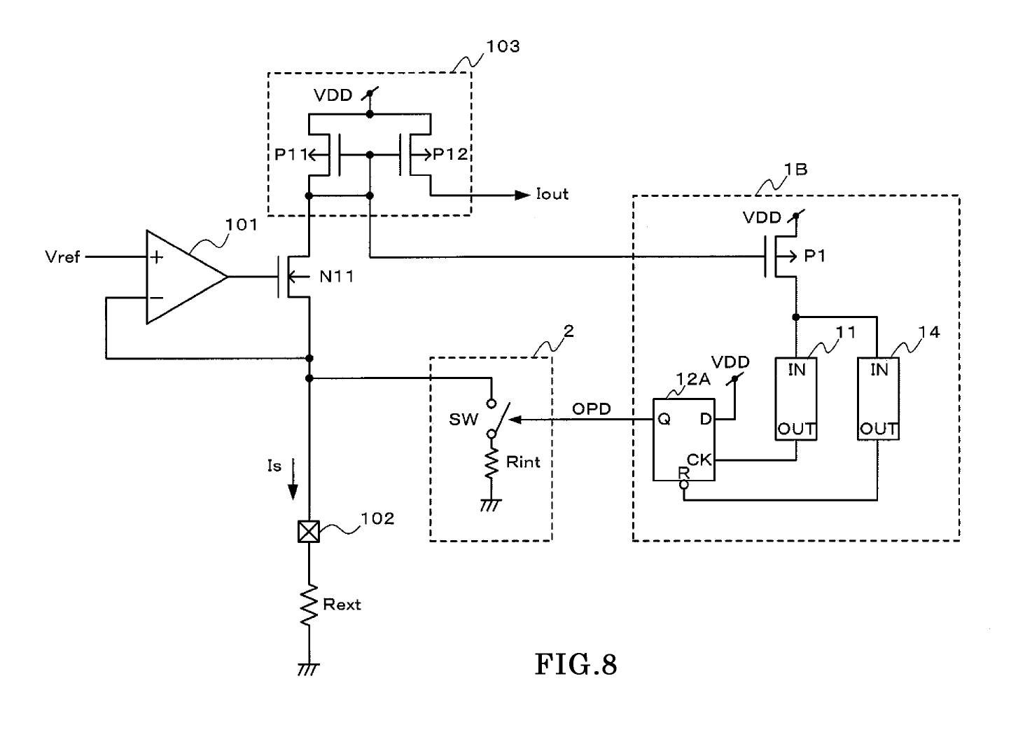

FIG. 8 shows a circuit illustrating an exemplary structure of a constant current circuit according to a fifth embodiment. The fifth embodiment is a case in which the detection circuit 1 of the first embodiment is replaced with a detection circuit 1B.

The detection circuit 1B differs from the circuit structure of the detection circuit 1 in that a detection circuit 14 is added, the detection circuit 14 being connected to a drain terminal of a PMOS transistor P1 and returning a current, and the latch 12 is replaced with a latch 12A having a reset terminal. An output of the detection circuit 14 is inputted to the reset terminal of the latch 12A.

The output of the detection circuit 14 is the H-level when a connection between an external terminal 102 and an external resistance Rext is normal or in an open state. The output of the detection circuit 14, however, turns to the L-level when the connection once becomes an open state and thereafter returns to a state in which a reference current Is flows in the external terminal 102 by re-connection of the external resistance Rext.

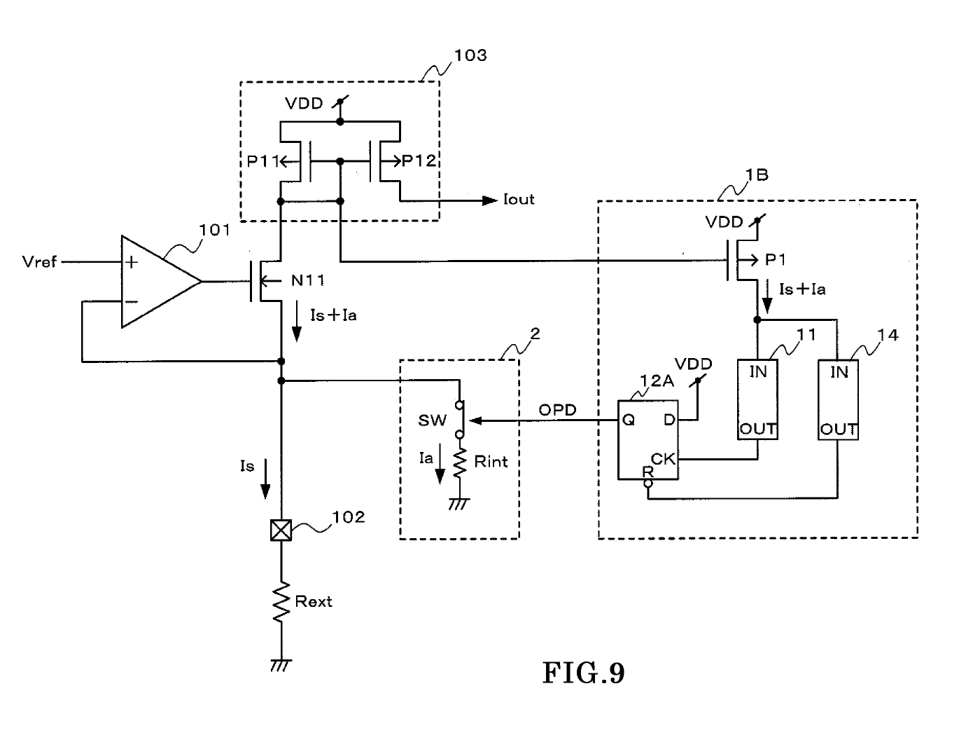

The operation of the detection circuit 1B is described below with reference to FIG. 9.

As illustrated in FIG. 9, a current flowing in an NMOS transistor N11 is a sum current of an alternative current Ia and the reference current Is, i.e., (Ia+Is), because the reference current Is also starts to flow in addition to the alternative current Ia when the external resistance Rext is connected again after an open state once occurs. Accordingly, a current which is equal to a current supplied to a current mirror circuit 103, i.e., (Ia+Is), flows in a drain terminal of a PMOS transistor P1 which forms a mirror circuit together with a PMOS transistor P11 of the current mirror circuit 103, when a mirror ratio is one.

Thus, the detection circuit 14 monitors a current flowing in the drain terminal of the PMOS transistor P1, and turns the output of the detection circuit 14 to the L-level when detecting that the current turns to (Ia+Is) from Ia.

When the output of the detection circuit 14 turns to the L-level, the latch 12A turns to a reset state whereby an open state detection signal OPD serving as an output of the latch 12A turns to the L-level.

When the open state detection signal OPD turns to the L-level, a switch SW of an alternative circuit 2 turns off whereby the supplying of the alternative current Ia to the current mirror circuit 103 is stopped. Consequently, the reference current Is alone is supplied to the current mirror circuit 103 and the current mirror circuit 103 outputs an output current Iout corresponding to the reference current Is.

According to the embodiment described above, a constant current can be consistently provided even when a connection state between the external terminal 102 and the external resistance Rext is unstable.

Note that, although the embodiment describes an example in which replacement is carried out with respect to the first embodiment, the same replacement as the embodiment can also be carried out with respect to the other embodiments.

The constant current circuit of at least one embodiment described above can provide a normal output current even when a defect occurs at a connection of the external resistance.

In addition, bipolar transistors may be used instead of the MOS transistors depending on breakdown voltages of elements, for example. Furthermore, a noise removing filter may be provided between the comparator 13 and the latch 12.

Other embodiments of the present disclosure will be apparent to those skilled in the art from consideration of the specification and practice of the disclosure disclosed herein. It is intended that the specification and example embodiments be considered as exemplary only, with a true scope and spirit of the disclosure being indicated by the claims that follow. The disclosure can be carried out by being variously modified within a range not deviated from the gist of the disclosure.

What is claimed is:

1. A constant current circuit, comprising:
a current mirror circuit generating an output current;
an external terminal to which an external resistance is connected, a reference current to be supplied to the current mirror circuit depending on the external resistance;
a first detection circuit detecting an open state of the external terminal; and
an alternative circuit supplying an alternative current corresponding to the reference current into the current mirror circuit when the first detection circuit detects the open state.

2. The constant current circuit of claim 1, wherein
the first detection circuit outputs an open state detection signal when the first detection circuit detects a state in which a current flowing toward the external terminal is decreased below the reference current.

3. The constant current circuit of claim 2, wherein
the first detection circuit includes a second detection circuit, and the second detection circuit outputs the open state detection signal.

4. The constant current circuit of claim 2,
wherein the first detection circuit stops outputting the open state detection signal when the first detection circuit detects a state in which the current flowing toward the external terminal returns after outputting the open state detection signal.

5. The constant current circuit of claim 4, wherein
the first detection circuit includes a third detection circuit connected to the second detection circuit in parallel, and the third detection circuit stops the output of the open state detection signal when the third detection circuit detects a state that the current flowing toward the external terminal returns after outputting the open state detection signal.

6. The constant current circuit of claim 1, wherein the first detection circuit includes a pull-up resistance connected between the external terminal and a power source voltage line, and outputs an open state detection signal when the first detection circuit detects a state in which a voltage of the external terminal is increased beyond a normal voltage of the external terminal.

7. The constant current circuit of claim 6, wherein
the first detection circuit includes a comparator to compare a sum of a reference voltage and a power source voltage applied through the pull-up resistance with a comparative voltage serving as a reference.

8. The constant current circuit of claim 7, wherein the comparative voltage is larger than the reference voltage and smaller than the power source voltage.

9. The constant current circuit of claim 2, wherein
the alternative circuit includes an internal resistance and a switch, and the switch connects the internal resistance to the external terminal when the open state detection signal is outputted.

10. The constant current circuit of claim 2, wherein
the alternative circuit includes a constant current source and a switch, and the switch connects the constant current source to the current mirror circuit as a supply source of the reference current when the open state detection signal is outputted.
